(19) United States
(12) Patent Application Publication
(10) Pub. No.: US 2017/0130099 A1
(43) Pub. Date: May 11, 2017

(54) EDGE STRIP

(71) Applicant: DÖLLKEN-KUNSTSTOFFVERARBEITUNG GMBH, Gladbeck (DE)

(72) Inventors: Martin OTTOW, Essen (DE); Jordanis PETRAKIS, Wuppertal (DE); Stephan SCHUNCK, Muenster (DE); Domingo ROHDE, Kiel (DE)

(21) Appl. No.: 15/319,333

(22) PCT Filed: Jul. 6, 2015
(86) PCT No.: PCT/EP2015/065388

§ 371 Date: Dec. 15, 2016

(30) Foreign Application Priority Data
Jul. 11, 2014 (DE) 10 2014 109 750.5
Apr. 9, 2015 (EP) 15163035.7

(51) Int. Cl. C09J 7/02; B32B 27/18; B32B 27/30; B32B 27/32; C09J 9/02; B32B 27/36; B32B 27/40; B32B 7/12; A47B 96/20; B32B 27/08; B32B 27/34

(52) U.S. Cl. CPC C09J 7/0242; B32B 27/08; B32B 27/18; B32B 27/304; B32B 27/32; B32B 27/34; B32B 27/36; B32B 27/365; B32B 27/40; B32B 7/12; A47B 96/201; C09J 9/02; B32B 2264/105; B32B 2274/00; B32B 2307/202; B32B 2307/204; B32B 2307/208; B32B 2310/0862; B32B 2451/00; B32B 2479/00

(57) ABSTRACT

The invention relates to an edge strip for coating the narrow edge surface of a panel-type workpiece, in particular furniture panels, comprising at least one base coat and a melt layer for attaching the edge strip to the workpiece. The melt layer has a dielectric loss factor ε_{SS} for microwave radiation that is greater than the dielectric loss factor ε_{GS} of the base coat.

The invention relates to an edge strip for coating the narrow edge surface of a panel-type workpiece, in particular furniture panels, comprising at least one (front) base coat and a (rear) melt layer for attaching the edge strip to the workpiece. Such edge strips or cover strips are also simply called edges or edge braces or also edgings. The panel-type workpieces or furniture panels can particularly be wood-based material panels, for example chipboards, fiberboards or the like. However, panels made of other materials as well as composite panels are also included. The base coat is also called the top coat because it refers to the front layer of the edge strip that is visible in its mounted state. The rear side of this base coat carries the melt layer with which the edge is attached (adhesively) to the workpiece in the course of the assembly. However, the edge strip can also comprise further layers.

It is basically known that a hot-melt adhesive for attaching edge strips on narrow edge surfaces of furniture panels is applied for of attaching or immediately before attaching the cover strip. The cover strip is attached in a so-called edge brace gluing machines. One of the problems with such attaching of the cover strip to the narrow face of furniture panels is that a visible gap can develop between the cover strips and the furniture panels or their narrow edge surfaces. This gap results essentially from the hot-melt adhesive. An adhesion agent layer is routinely added that is used to attach cover strips made of thermoplastic plastic on the narrow faces of furniture panels.

In order to prevent such unsightly hot-melt adhesive gaps that become clearly visible particularly during use or cleaning, it has already been proposed to completely forego a hot-melt adhesive layer. Therefore, EP 1 163 864 discloses an adhesive-free connection between a cover strip or plastic edging strip and a furniture panel, i.e. the plastic edge is fitted directly and without adhesive onto the furniture panel. For such purpose, the surface of the plastic edging strip is fused, for example by laser radiation or also hot air.

Alternatively, EP 1 852 242 proposes the use of a cover strip with a melt adhesive layer applied on one side of the cover strip, and the cover strip with the melt adhesive layer is produced by coextrusion. This way, the melt adhesive layer is preferably dyed in the color of the cover strip, so the cover strip can be attached to a furniture panel without a visible adhesive gap being noticeable. The melt adhesive or the melt adhesive layer can be melted or activated by laser radiation.

WO 2009/026977 [U.S. Pat. No. 8,603,610] describes an edge strip for furniture pieces that comprises a melt layer. This melt layer is supposed to contain both polar and unpolar parts in the molecular structure. For processing, the melt adhesive is heated by applying energy. The energy can be introduced for example in the form of laser light, hot air, microwaves, ultrasound, etc., and an energy absorbent (for example laser pigments) preferably contained in the melt layer absorbs the energy introduced by the energy application means and heats the melt layer above the melting point.

Therefore, there is an overall need to make available edge strips for coating a narrow edge surface of a panel-type workpiece, in particular furniture panels, provided with a melt layer or functional layer that can be fused by suitable sources, for example by laser radiation or also plasma radiation, and permanently applied with contact pressure to the furniture panel. First embodiments have become established in practice in connection with the use of laser radiation or also hot air. If the melt layer is fused with laser radiation, such a functional layer is possibly provided with laser-absorbing additives. A disadvantage of such functional layers with laser-absorbing additives is the color-dependent activation of the laser-absorbing melt layer. This disadvantage must be compensated for with a color-dependent formulation of the functional layer as well as with color-dependent laser power. The fact that the laser activation possibly also heats the base coat to some extent and thus also the actual molding is a disadvantage when using laser radiation because it can lead to a negative influence on the shape. Therefore, there is a need for alternative concepts. This is where the invention applies.

The object of the invention is to create an edge strip for the coating of the narrow edge surface of a panel-type workpiece, in particular furniture panels of the above-described type in which the melt layer can be fused specifically selectively.

For the solution of this problem, the invention teaches an edge strip for the coating of the narrow edge surfaces of the initially described type with a melt layer that has a dielectric loss factor ε_{SS} for microwave radiation that is greater than the dielectric loss factor ε_{GS} of the base coat.

Within the framework of the invention, microwave radiation refers to electromagnetic radiation with a frequency of 300 MHZ to 300 GHz. At first, the invention proceeds from the knowledge that microwave radiation for fusing a melt layer also comes into consideration for the processing of edge strips. According to the invention, an edge strip with at least two layers, i.e. the (front) base coat or top coat and the (rear) melt layer is used. After assembly, the base coat or top coat forms the visible side of the edge strip. As a rule, the melt layer is significantly thinner than the top coat, and so the top coat itself is essentially the edge strip while the melt layer, also called the functional layer, essentially serves to adhere the strip to the workpiece. The embodiment according to the invention allows for a selective activation of the functional layer by microwave radiation because the melt layer, due to its design, can be heated and thus fused with a high dielectric loss factor and thus with high dielectric losses in the microwave range, while the base coat of the edge strip is designed such that it does not heat up or only slightly heats up due to merely minor dielectric losses. Electric energy is thus transformed into heat by dielectric losses and therefore by interaction of polar groups of molecules of nonconducting substances with the alternating electric field of the electromagnetic oscillation. A measurement for this dielectric behavior is the dielectric constant that is a frequency-dependent, complex variable ε=ε′−i ε″. Within the scope of the present invention, the imaginary part ε″ of this dielectric constant is called the loss factor ε. According to the invention, the melt layer, due to the high dielectric loss factor ε_{SS}, can be easily heated with microwave radiation, while the base coat, due to the small loss factor ε_{SS}, is not or only insignificantly heated. The ratio R between the dielectric loss factor ε_{SS} of the melt layer and the dielectric loss factor ε_{GS} of the base coat is therefore, according to the invention, greater than 1 (R=ε_{SS}/ε_{GS}>1). It is practical if this ratio R is significantly greater than 1, for example R>2. Preferably, R>5, particularly preferably, R>10.

According to the invention, the specified loss factors or their ratios relate to microwave radiation in a frequency range between preferably 800 MHZ and 5 GHz. For that purpose, the materials for the melt layer and the base coat are preferably adapted for microwave radiation from an ISM frequency band (industrial, scientific and medical band). For example, the specified loss factors relate to microwave radiation in a frequency range from 902 MHZ to 928 MHZ, for example 905 MHZ, or a frequency range from 2.4 GHz to 2.5 GHz, for example 2.45 GHz, or a frequency range from 5.7 GHz to 5.9 GHz, for example 5.8 GHz.

According to the invention, the melt layer is made of a thermoplastic plastic or made on the basis of a thermoplastic plastic. The loss factor ε_{SS} of the melt layer preferably has a value greater than 0.5, for example greater than 1. It is furthermore within the scope of the invention that the loss factor ε_{SS} of the melt layer has a value of less than 50. The loss factor is thus preferably in a range from 0.5 to 20, particularly preferably 1 to 15, for example 1 to 10. The loss factor of the melt layer refers to room temperature (approximately 20° C.)

The base coat preferably consists of at least one thermoplastic polymer. However, alternatively, other materials, for example wood and/or paper materials are possible as base coat. For example, paper-based melanin edges or wood veneer edges can be used as base coat. However, thermoplastic plastics and thus thermoplastic plastic edges are preferably used. The base coat particularly preferably consists of thermoplastic polymer from the group of polystyrenes (for example ABS), polyvinyl chlorides (for example PVC-U), polyolefins (for example PP or PE), polycarbonate (PC), or polymethyl methacrylates (PMMA) as well as polyamides (PA). The base coat can be optionally reinforced with fillers of the mineral type, for example calcium carbonate, silicates from the group of the magnesium-aluminum silicates, such as talcum, kaolin, wollastonite, or with mica.

The melt layer and thus the layer activated by microwaves preferably consists of at least one thermoplastic polymer from the group of polystyrenes (for example ABS), polyvinyl chloride (for example PVC-U), polyolefins (for example PP or PE), polyamides (PA), thermoplastic elastomers on polyolefin basis, or styrene block copolymers, thermoplastic copolyesters, copolyamides, or polymethyl methacrylates. Alternatively, vinyl acetate ethylene copolymers or methacrylate ethylene copolymers are possible. Preferably, a thermoplastic polymer on the basis of thermoplastic polyurethane (TPU) or an atactic polyalphaolefin (APAO) can be used for the melt layer.

Basically, it is recommended to use thermoplastic polymers that, due to dielectric losses, can be heated to a suitable extent with microwaves. Particularly preferably, the melt layer is provided with one or more additives for increasing the dielectric loss factor.

Additives from the group of paramagnetic metals or materials, or ferrimagnetic metals or materials, can be used as additives. For example, these can be spinels, garnets, or ferrites. Alternatively, carbon in different modifications is possible.

In addition, electrically conducting particles (for example soot) or particles with an electrically conducting coating can be used as additives. The particles with electrically conducting coating can for example be mineral particles, for example silicates or sheet silicates (for example mica or the like) with an electrically conducting coating. For the electrically conducting coating of such mineral particles, for example (optically transparent) electrically conducting oxides can be used, for example antimony tin oxide. This is preferably antimony(Sb)-doped tin oxide, for example tin(IV) oxide (SnO₂) or tin(II, IV) oxide (Sn₂O₃) or alternatively also tin(II) oxide (SnO). Such transparent or color neutral additives that consist of mica particles and are coated with antimony-doped tin, are, for example available at Merck under the product name Iriotec (formerly Minatec). For example, particularly preferred is the use of an additive with the name Iriotec 7315 or Minatec 51. Such “conducting pigments” are thus commercially available and have been used, for example for producing antistatic floors or for producing conducting primers. According to the invention, they are used as additives for increasing the dielectric losses of the plastic melt layer.

The content of the additives (for example the electrically conducting additives) in the melt layer can be in a range from 2% to 15%, preferably 5% to 10%, each based on the weight. For example, powdery additives with a grain size from 1 to 100 μm, preferably 10 μm to 60 μm, are used.

The use of additives for increasing the dielectric losses is practical only if the melt layer is made of thermoplastic plastic that itself has a low dielectric loss. According to the invention, additives are used, for example for melt layers on polyolefin basis or TPU basis.

The high dielectric losses ε (i.e. ε″_{eff}) are the common physical property of these substances. The additives mentioned can as described be added (directly) to the melt layer or the material of the melt layer during manufacture. Alternatively, it is possible to provide such additives, for example in a solvent as a separate layer. The separate layer with additives can be applied to the melt layer, i.e. to the side of the melt layer facing the base coat, or alternatively also be provided between the base coat or edge and the melt layer.

The edge strip according to the invention consisting of the base coat and the melt layer can be produced using coextrusion or post-coextrusion. However, alternatively, the melt layer can also be applied to the base coat or top coat by post-coating. If an additional layer, for example the separate layer with additives described above, is provided, it can be preferably applied using a coating process.

1. An edge strip for coating the narrow edge surface of a panel-type workpiece, the edge strip comprising:
at least one base coat having a dielectric loss factor ε_{GS}; and
a melt layer for attaching the edge strip to the workpiece and having a dielectric loss factor ε_{SS} for microwave radiation that is greater than the dielectric loss factor of the base coat.

2. The edge strip according to claim 1, wherein a ratio R between the dielectric loss factor ε_{SS} of the melt layer and the dielectric loss factor E_{SS} of the base coat is greater than 2.

3. The edge strip according to claim 1, wherein the loss factor of the melt layer is greater than the loss factor of the base coat with respect to microwave radiation with a frequency of 902 MHZ to 928 MHZ, or microwave radiation with a frequency of 2.4 GHz to 2.5 Ghz, or microwave radiation with a frequency of 5.7 GHz to 5.9 Ghz.

4. The edge strip according to claim 1, wherein the dielectric loss factor ε_{SS} of the melt layer has a value greater than 0.5.

5. The edge strip according to claim 1, wherein the dielectric loss factor ε_{SS} of the melt layer has a value of less than 50.

6. The edge strip according to claim 1, wherein the base coat consists of at least one thermoplastic polymer from the group of polystyrenes, polyvinyl chlorides, polyolefins, polycarbonate, or polymethacrylates or polyamides.

7. The edge strip according to claim 1, wherein the melt layer consists of at least one thermoplastic polymer from the group of polystyrenes, polyvinyl chloride, polypropylene, polyethylene, polyamide, a thermoplastic elastomer on polyolefin basis, a styrene block copolymer, a thermoplastic copolyester, a thermoplastic, a thermoplastic polymethacrylates, a thermoplastic polyurethanes, a vinyl acetate ethylene copolymer, a methacrylate ethylene copolymer.

8. The edge strip according to claim 1, wherein the melt layer contains with additives for increasing its dielectric loss factor.

9. The edge strip according to claim 8, wherein at least one additive from the group of paramagnetic metals or materials or ferrimagnetic metals or materials is used.

10. The edge strip according to claim 8, wherein the additives contain electrically conducting particles or mineral particles with an electrically conducting coating.

11. The edge strip according to claim 1, produced by coextrusion, post-coextrusion or post-coating of a base coat with a melt layer.
